(19) United States
(12) Patent Application Publication
(10) Pub. No.: US 2002/0061059 A1
(43) Pub. Date: May 23, 2002

(54) Scheme for the initialization of ADSL modems

(76) Inventor: Alberto Ginesi, Nepean (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/915,191

(22) Filed: Jul. 24, 2001

(30) Foreign Application Priority Data
Jul. 24, 2000 (CA) 2,314,405

(51) Int. Cl. H04B 1/38

(52) U.S. Cl. 375/219

(57) ABSTRACT

Method and apparatus for improving asymmetric digital subscriber line (ADSL) communication over long loop distances. The method includes identifying sub-channels having an anticipated highest performance for communication, communicating the identified sub-channels between first and second ADSL transceivers, and transmitting initialization information for the communications link over the identified sub-channels. This improves link performance over a traditional system that uses fixed sub-channels for transmitting the initialization information.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

The present invention relates generally to transfer of data using Digital Subscriber Loop (DSL) technology, and specifically to an improved scheme for initializing the transfer.

Remote access and retrieval of data is becoming increasingly popular in data communication. The proliferation of the Internet has provided a vast network of information that is available to the general public. As the Internet grows and technology advances, this information is becoming increasingly voluminous and the details are becoming increasingly intricate. What used to comprise mainly text information has grown to include still and moving images as well as sound. The increase in the volume of information to be transferred has presented a need for a high-speed Internet connection, since traditional telephone modems communicate at speeds too slow for efficient communication.

One proposal for high-speed communication is the introduction of Digital Subscriber Line (DSL) technology. One of the most attractive features of DSL is that it is implemented using an infrastructure that already exists. DSL shares copper twisted pair lines typically used for telephone communication. However, only a small portion of the available bandwidth of the twisted pair line (0 to 4 kHz) is used for Plain Old Telephone Service (POTS). DSL takes advantage of the available frequency spectrum from 4 kHz to approximately 1.1 MHz for transmitting data.

Asymmetric DSL (ADSL) is currently the most practical form of DSL technology, and therefore the most widely implemented. ADSL is asymmetric in that its downstream (to a subscriber) capacity is larger than its upstream (from the subscriber) capacity. Typically, a Discrete Multi-tone (DMT) scheme is used. The spectrum from 4 kHz to 1.1 MHz is divided into 256 sub-channels, or tones, each having a bandwidth of 4.3125 kHz. Each sub-channel uses Quadrature Amplitude Modulation (QAM) to carry 2 to 15 bits/QAM symbol.

According to the ADSL International Telecommunications Union (ITU) G.992.2 standard, several phases occur in order to initialize a communication link. These phases include handshaking, transceiver training, channel analysis and exchange.

Handshaking is used for determining the nature and capabilities of communication endpoints (such as an ADSL modem) and for indicating which protocol will be used for the remainder of the initialization. The ADSL modem, or termination unit, at a central office is referred to as an ATU-C. Similarly, the ADSL termination unit at the subscriber, or remote location, is referred to as the ATU-R.

The signaling method used for the handshake interchange is designed to be robust. Biphase shift keying (BPSK) modulation is used to modulate multiple single-tone sub-carriers, all carrying the same data. Typically, the ATU-C and ATU-R exchange a message containing information about the endpoint type, frequency range, and number of DMT sub-carriers supported.

During transceiver training, the transceivers at each end of the line acquire a DMT symbol stream, adjust receiver gain, perform symbol-timing recovery, and train any equalizers. There is an optional echo cancellation training step that can also be performed during this phase.

During channel analysis, the transceivers exchange capability information and perform detailed channel characterization. Both the ATU-R and ATU-C attempt to measure specific channel characteristics such as unusable sub-carriers, loop attenuation on a per sub-carrier basis, signal-to-noise ratios (SNRs), and any other channel impairments that would affect the potential transmitted bit rates. Based on the discovered channel characteristics, the ATU-C makes the first offer of the overall bit rates and coding overhead that will be used for the connection.

The exchange phase sets the final overall transmission rates in both the upstream and downstream directions for the connection. These final rates are determined based on calculated channel parameters measured during the channel analysis phase, and are not necessarily the same as the preliminary rates offered during that phase.

Furthermore, the exchange phase sets forward error correction (FEC) and interleaver configurations. Generally, the configurations are close to the optimum bit rate for the channels. Four carriers are used to modulate the bits of the messages, each carrier being loaded with 2 bits using quadrature phase shift key (QPSK) modulation.

Since the ATU-C controls data rates, if the ATU-R cannot support any of the offered rates, both terminals will return to the beginning of the initialization process. Otherwise the ATU-R responds with the rate it can support.

The information transferred during the exchange is important for establishing the communication between the ATU-C and the ATU-R. Therefore, the same bits are also modulated into a set of back-up tones for improving robustness. The tone sets used by G.992.1 Annex A and G.992.2 standards are provided below in TABLE 1.

TABLE 1

| | Primary Set (Index No.) | Backup Set (Index No.) |
|---|---|---|
| Upstream | 43, 44, 45, 46 | 91, 92, 93, 94 |
| Downstream | 10, 11, 12, 13 | 20, 21, 22, 23 |

Further details of the above-described process are described below with reference to FIGS. 1 and 2.

Referring to FIG. 1, a system for implementing ADSL service is illustrated generally by numeral 100. The system 100 comprises a central office transceiver (ATU-C) 102, a splitter 104, a twisted pair loop 106, and a remote transceiver (ATU-R) 108. The splitter 104 includes a high pass filter 110 and a low pass filter 112. The ATU-C 102 is coupled between a broadband network 114, such as the Internet, and the high pass filter 110 of the splitter 104. The low pass filter 112 of the splitter 104 is coupled to a narrowband network 116 such as a General Switched Telephone Network (GSTN) or Integrated Services Digital Network (ISDN). Output from the high pass 110 and low pass filters 112 are combined and coupled with the twisted pair loop 106.

The twisted pair loop is, in turn, coupled with a customer-premises wiring network 118. The customer-premises wiring network 118 is coupled via a low pass filter 112 with narrowband network devices 120, such as telephones, voiceband modems, and ISDN terminals. The customer-premises wiring network 118 is further coupled to the ATU-R 108 via a high pass filter 110. The ATU-R 108 is further coupled to a plurality of service modules 122 via a home network 124.

The system 100 illustrated in FIG. 1 operates by transferring data between the ATU-C 102 and the ATU-R 108 on a frequency spectrum above that used for the narrowband devices 120. Therefore, the system 100 provides the service modules 122 access to a high-speed network connection across the twisted pair loop 106, which is an existing infrastructure.

Often, the twisted pair loop 106 is long, resulting in an increase in the bit error ratio (BER) for the transmission. This is particularly important during the exchange, since the transmission parameters are established at this point. As it is known, the BER for QPSK modulation is

BERᵢ=Q(\sqrt{SNR}ᵢ) (1)

and the overall BER over the 4 carriers (i.e. the average BER for the decoded message) is

$$BER = \frac{1}{4} {\sum }_{i = 1}^{4} {BER}_{i} \qquad ( 2 )$$

The Message Error Rate (MER) for a given message of L bits is then

MER=1−(1−BER)^{L} (3)

The initialization message includes cyclic redundancy check (CRC) bytes; therefore, L is the number of bits of the message the CRC bytes are computed from. Because the MER increases with L, one should consider the max value of L (Lₘₐₓ) for the initialization messages when evaluating the reliability of the messaging scheme.

The following messages and corresponding message sizes are transferred during the exchange.

Downstream

The first group of messages includes C-RATES-RA, C-CRC-RA1, C-MSG-RA, and C-CRC-RA2. The messages comprise 960 bits for C-RATES-RA, 16 bits for C-CRC-RA1, 48 bits for C-MSG-RA, and 16 bits for C-CRC-RA2, yielding a total of 1,040 bits or 130 Discrete Multi-tone (DMT) symbols.

The second group of messages includes C-MSG2, C-CRC3, C-RATES2, and C-CRC4. The messages comprise 32 bits for C-MSG2, 16 bits for C-CRC3, 8 bits for C-RATES2, and 16 bits for C-CRC4, yielding a total of 72 bits, or 9 DMT symbols.

The third group of messages includes C-B&G and C-CRC5. The messages comprise 496 bits for C-B&G and 16 bits for C-CRC5, yielding a total of 512 bits, or 64 DMT symbols.

Upstream

The first group of messages includes R-RATES-RA, R-CRC-RA2, R-MSG-RA, and R-CRC-RA1. The messages comprise 8 bits for R-RATES-RA, 16 bits for R-CRC-RA2, 80 bits for R-MSG-RA, and 16 bits for R-CRC-RA1, yielding a total of 120 bits, or 15 DMT symbols.

The second group of messages includes R-MSG2, R-CRC3, R-RATES2, and R-CRC4. The messages comprise 32 bits for R-MSG2, 16 bits for R-CRC3, 8 bits for R-RATES2, and 16 bits for R-CRC4, yielding a total of 72 bits, or 9 DMT symbols.

The third group of messages includes R-B&G and R-CRC5. The messages comprise 4080 bits for R-B&G and 16 bits for R-CRC5, yielding a total of 4096 bits, or 512 DMT symbols.

Therefore, it can be seen that the maximum bit length for a downstream message is Lₘₐₓ=960 for C-RATES-RA. For upstream, the maximum bit length is Lₘₐₓ=4080 for R-B&G.

In order to have the MER<10⁻², substituting the values of Lₘₐₓ from Equation (3) results in:

Downstream (Lₘₐₓ=960) BER<10⁻⁵

Upstream (Lₘₐₓ=4080) BER<2.5·10⁻⁶

In terms of the required signal-to-noise ratio (SNR) in the carriers, this means the upstream messages require only a fraction of a dB higher SNR to compensate for the longer message.

Referring to FIG. 2, a timing diagram for the exchange in accordance with the state of the art is illustrated generally by numeral 200. Generally, the nomenclature for message transmission uses an “R-” prefix for indicating that the message originated from the ATU-R, and a “C-” prefix for indicating that the message originated from the ATU-C. The sequence of messages on the left side represents messages sent from the ATU-C to the ATU-R and the sequence of message on the right side represents messages sent from the ATU-R. For both sides, the message sequence begins at the top of the page.

After C-MEDLEY 202 the ATU-C enters C-REVERB4 204 where it waits for messages 206 from the ATU-R. The messages 206 include R-RATES-RA, R-CRC-RA2, R-MSG-RA, and R-CRC-RA1. If the expected messages 206 are not received within 6,000 symbols, the ATU-C times out and the initialization fails. If the ATU-C receives the expected messages in the allotted time, it remains in C-REVERB4 204 for at least another 80 symbols before it enters C-SEGUE2 208. After C-SEGUE2 208, the ATU-C transmits a series of messages 210 to the ATU-R. These messages 210 include C-RATES-RA, C-CRC-RA1, C-MSG-RA, and C-CRC-RA2.

Once the ATU-R has sent its messages 206 it enters R-REVERB-RA 212, where it waits for the messages 210 from the ATU-C. If the ATU-R does receive the messages 210 within 4,000 symbols, it times out and the initialization fails. The ATU-C and ATU-R use predefined tone indices for transmitting the messages R-RATES-RA, R-CRC RA2, R-MSG-RA, R-CRC-RA1, C-RATES-RA, C-CRC-RA1, C-MSG-RA, and C-CRC-RA2. An additional set of tone indices is used to transmit these messages as a backup.

Optimally, the receiver combines the bits carried in the two sets of tone for improving reliability of the transmission. However, the signal-to-noise ratio (SNR) in the frequency band of the backup tone is much lower than that in the frequency band of the primary tone. Therefore, on long loops, especially for the downstream tones, the backup set of tones is essentially ineffective. In these cases, the bit error ratio (BER) is determined by the SNR on the primary set. Within a set, the highest BER within the four carriers determines the overall bit error rate on the message.

As a result, increasing the number of sets of carriers has limited benefits, since it does not guarantee best performance and further complicates the messaging protocol. Furthermore, as is often the case, the tone assigned by the designated indices may have a poor SNR, causing the initialization to fail.

Therefore, there is a need for a messaging protocol that improves the reliability of the messages transferred during the initialization. It is an object of the present invention to obviate or mitigate at least some of the above-mentioned disadvantages.

### BRIEF SUMMARY OF THE INVENTION

In accordance with an aspect of the present invention, there is provided a method for initializing a communication link between a first transceiver and a second transceiver for transferring data therebetween. The method comprises the steps of analyzing channel properties of a plurality of sub-channels within the communication link, identifying a predefined number of sub-channels having an anticipated highest performance for communication, communicating the identified sub-channels between the first and second transceivers, and transmitting information for initializing the communication link using the identified sub-channels.

### BRIEF DESCRIPTION OF THE DRAWINGS

An embodiment of the invention will now be described by way of example only with reference to the following drawings in which:

FIG. 1 is block diagram illustrating a typical system for providing ADSL service (prior art);

FIG. 2 is a block diagram illustrating the flow of data during the exchange (prior art);

FIG. 3 is a block diagram illustrating the flow of data during the exchange in accordance with an embodiment of invention;

FIG. 4a is a graph illustrating the performance of the initialization process over a varying loop length with 24 ADSL NEXT and FEXT;

FIG. 4b is a graph illustrating the performance of the initialization process over a varying loop length with 24 DSL NEXT; and

FIG. 5 is a block diagram of an ATU-C and an ATU-R that implement the present invention.

### DETAILED DESCRIPTION OF THE INVENTION

For convenience, like numerals in the description refer to like structures in the drawings.

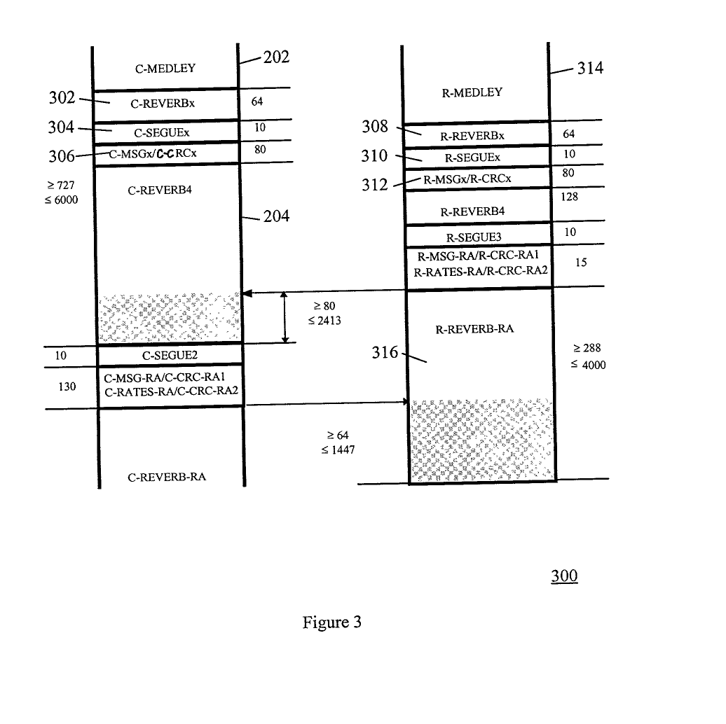

Referring to FIG. 3, a timing diagram for improving the reliability of the exchange is illustrated generally by numeral 300. Additional ATU-C transmissions C-REVERBx 302, C-SEGUEx 304, and C-MSGx/C-CRCx 306 are inserted between C-MEDLEY 202 and C-REVERB4 204. Similarly, additional ATU-R transmissions R-REVERBx 308, R-SEGUEx 310, and R-MSGx/R-CRCx 312 are inserted between R-MEDLEY 314 and R-REVERB4 316.

The content of the messages C-MSGx and R-MSGx includes the indices of four tones with the best SNR available. C-MSGx includes the indices for upstream communication and R-MSGx includes the indices for downstream communication. Therefore, rather than use fixed indexes to transfer the messages, the indices of the four tones are selected adaptively, in accordance with an estimated line SNR.

The indices of the four tones are selected by the ATU-C and ATU-R to correspond to tones with the best SNRs. The SNR estimate is available at the exchange because it takes place after both C-MEDLEY and R-MEDLEY (during channel analysis). During C-MEDLEY an estimate of the downstream SNR is determined at the ATU-R. The ATU-R determines the indices of the tones having the four highest SNRs for downstream communication and compiles them into R-MSGx. Similarly, during R-MEDLEY an estimate of the upstream SNR is determined at the ATU-C. The ATU-C determines the indices of the tones having the four highest SNRs for upstream communication and compiles them into C-MSGx. The sets of four indices, that is C-MSGx and R-MSGx, are exchanged between the ATU-R and the ATU-C using a more reliable 1-bit per symbol modulation.

The format of R-MSGx and C-MSGx is describes as follows. The message comprises a prefix, a first carrier index, a second carrier index, a third carrier index, and a fourth carrier index. The prefix is four bytes and each of the carrier indices is one byte as illustrated in Table 2 below.

TABLE 2

| | | Carrier | Carrier | Carrier | Carrier |
|---|---|---|---|---|---|
| | Prefix | index #1 | index #2 | index #3 | index #4 |
| Number of | 4 | 1 | 1 | 1 | 1 |
| bytes | | | | | |

The prefix is {01010101 0101010101010101 01010101}₂. The carrier index fields contain the four carrier indexes with the best SNR in decreasing order. Therefore, the SNR of carrier index #1 is greater than or equal to the SNR of carrier index #2, which is greater than or equal to the SNR of carrier index #3, which is greater than or equal to the SNR of carrier index #4. The byte for each carrier index is the binary representation of the selected index.

The message is followed by a 16-bit CRC that is transmitted using the same 1-bit/symbol modulation format. Thus, 80 DMT symbols are required for transmitting each of the 80-bit C-MSGx/C-CRCx message and 80-bit R-MSGx/R-CRCx message.

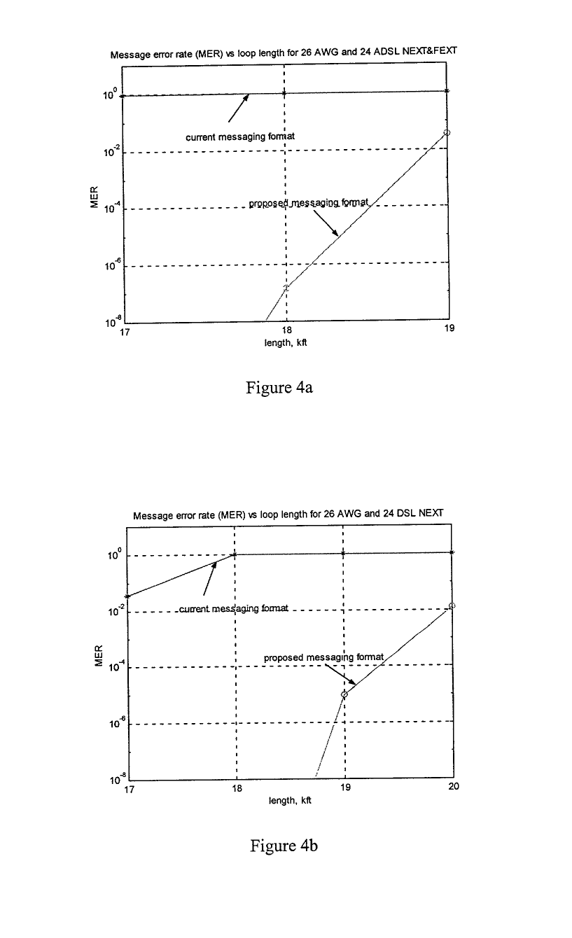

Referring to FIG. 4a and FIG. 4b the performance of the messaging scheme described herein is compared to that currently in use, with respect to the MER of C-RATES-RA. FIGS. 4a and 4b refer to two different cross talk scenarios. FIG. 4a has 24 ADSL near end cross talk (NEXT) and far end cross talk (FEXT). FIG. 4b has 24 DSL NEXT. The vertical axis represents an increase in the MER. The horizontal axis represents an increase in loop length. The loop lengths are selected in order to allow for a non-zero net throughput in presence of a coding scheme. In particular, when Reed Solomon (RS) FEC only is used, a non-zero throughput is guaranteed for the 17 kft and 18 kft loops in both FIGS. 4a and 4b. When Trellis and RS are used, reach can be extended to 19 kft with 24 ADSL NEXT and FEXT (FIG. 4a) and to 20 kft with 24 ADSL NEXT (FIG. 4b).

As illustrated in both FIGS. 4a and 4b, for these conditions the current standard messaging scheme is inadequate, since the MER approaches 1 for these loops. Therefore, even though the channel allows a non-zero net data rate, the unreliability of the messages does not allow the link to activate. However, the messaging scheme described in the preferred embodiment is sufficiently reliable for all of these cases. Furthermore, as a result of the improved reliability of the selected set of carriers, only one carrier set is required.

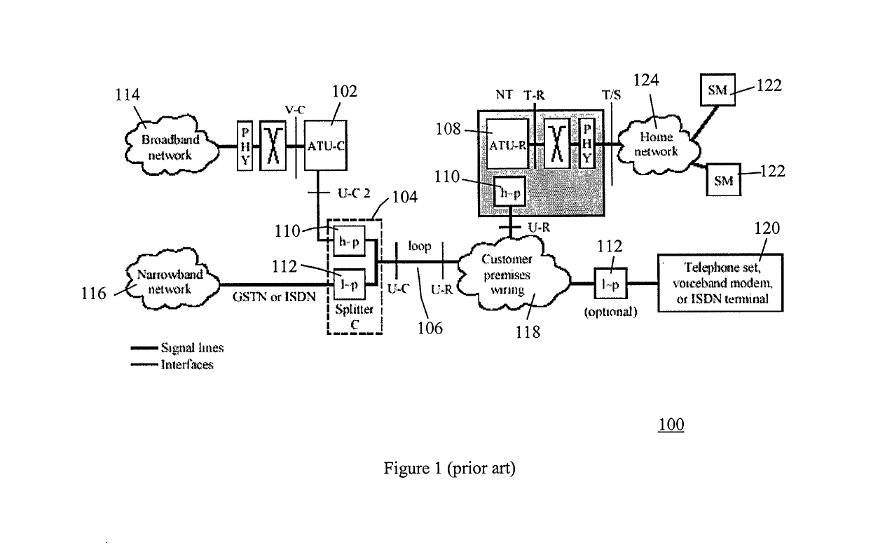

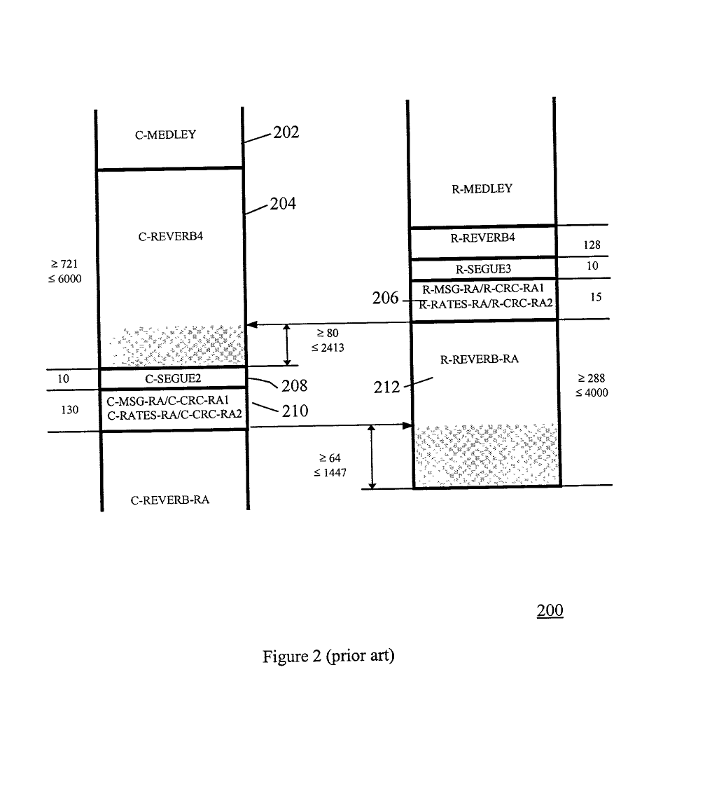

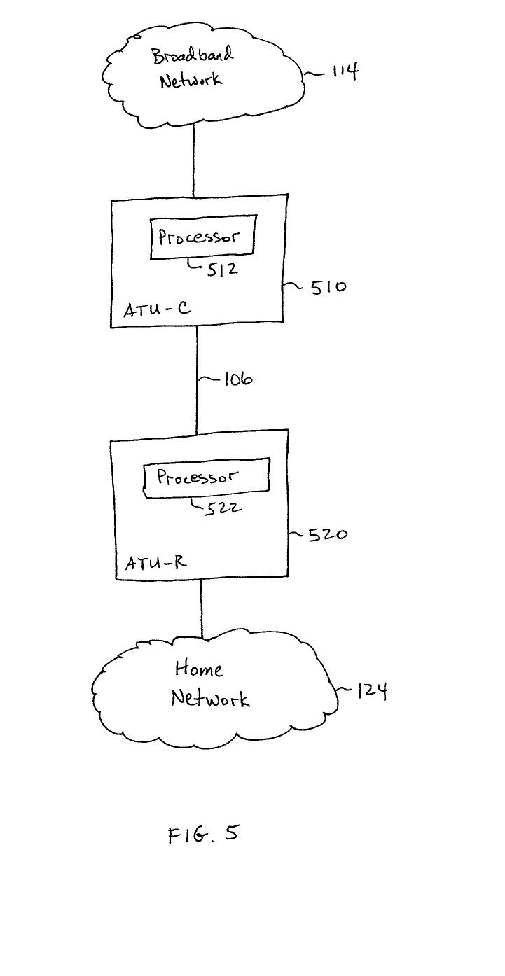

FIG. 5 shows an ATU-C 510 and an ATU-R 520 that implement the present invention. The conventional features in the figure generally correspond to FIG. 1 and are not further detailed. The ATU-C 510 includes a processor 512, and the ATU-R 520 includes a processor 522. In general, the processors 512, 522 control the ATU-C 510 and ATU-R 520 to implement the above-described messaging scheme. The processors 512, 522 may be implemented as specialized circuitry (e.g., an application-specific integrated circuit), a field-programmable gate array, as a general processor that is controlled by software (including microcode), or as a combination of two or more of these implementations.

In yet an alternate embodiment, each transceiver sends a stream of bits as numerous as the number of the tones capable of being received. Each bit corresponds to a tone. If a bit is set to 1 then its associated tone is to be used during for transmitting the messages that help establish the communications link. For example, the ATU-C transmits messages that include C-MSG-RA and C-RATES-RA. The ATU-R transmits messages that include R-MSG-RA and R-RATES-RA. If the bit is set to zero, its associated tone is not used for modulating the messages.

In all of the embodiments described above, it is possible to use greater or fewer than four tones for communicating the message as will be apparent to a person skilled in the art. Although the invention has been described with reference to certain specific embodiments, various modifications thereof will be apparent to those skilled in the art without departing from the spirit and scope of the invention as outlined in the claims appended hereto and their equivalents.

What is claimed is:

1. A method of initializing a communication link between a first transceiver and a second transceiver for transferring data therebetween, said method comprising:
analyzing channel properties of a plurality of sub-channels within said communication link;
identifying a predefined number of sub-channels having an anticipated highest performance for communication;
communicating said sub-channels between said first and second transceivers; and
transmitting information for initializing said communication link using said sub-channels.

2. The method of claim 1, wherein said anticipated highest performance is determined by a signal-to-noise ratio (SNR) of said sub-channels.

3. The method of claim 1, wherein said first transceiver identifies a first set of said sub-channels for upstream communication and said second transceiver identifies a second set of said sub-channels for downstream communication.

4. The method of claim 1, wherein said communicating further comprises communicating said sub-channels using a one bit per symbol modulation scheme.

5. The method of claim 1, wherein said act of communicating further comprises communicating a cyclic prefix in addition to said sub-channels.

6. The method of claim 1, wherein said act of communicating further comprises communicating a validity check in addition to said sub-channels.

7. The method of claim 1, wherein said information for initializing said communication link is transmitted using a two bit per symbol modulation scheme.

8. A method of initializing a communication link between a first transceiver and a second transceiver for transferring data therebetween, said method comprising:
identifying a predefined number of sub-channels having an anticipated highest performance for communication;
communicating said sub-channels between said first and second transceivers; and
transmitting information for initializing said communication link using said sub-channels.

9. An apparatus in an asynchronous digital subscriber line (ADSL) central office termination unit (ATU-C) for improving performance of a communication link, comprising a processor configured to control said ATU-C to execute processing that includes:
analyzing channel properties of a plurality of sub-channels within said communication link;
identifying a predefined number of first sub-channels having an anticipated highest performance for communication;
communicating, to an ADSL remote termination unit (ATU-R), said first sub-channels;
receiving, from said ATU-R, information identifying a predefined number of second sub-channels;
receiving, from said ATU-R using said second sub-channels, information for initializing said communication link; and
transmitting, to said ATU-R using said first sub-channels, information for further initializing said communication link.

10. The apparatus of claim 9, wherein said processor is further configured to control said ATU-C to communicate said first sub-channels using a one bit per symbol modulation scheme.

11. The apparatus of claim 9, wherein said processor is further configured to control said ATU-C to communicate a cyclic prefix in addition to said first sub-channels.

12. The apparatus of claim 9, wherein said processor is further configured to control said ATU-C to communicate a validity check in addition to said first sub-channels.

13. The apparatus of claim 9, wherein said processor is further configured to control said ATU-C to transmit said information for initializing said communication link using a two bit per symbol modulation scheme.

14. An apparatus in an asynchronous digital subscriber line (ADSL) remote termination unit (ATU-R) for improving performance of a communication link, comprising a processor configured to control said ATU-R to execute processing that includes:
analyzing channel properties of a plurality of sub-channels within said communication link;
identifying a predefined number of first sub-channels having an anticipated highest performance for communication;
communicating, to an ADSL central office termination unit (ATU-C), said first sub-channels;
transmitting, to said ATU-C using said first sub-channels, information for initializing said communication link;
receiving, from said ATU-C, information identifying a predefined number of second sub-channels; and
receiving, from said ATU-C using said second sub-channels, information for further initializing said communication link.

15. The apparatus of claim 14, wherein said processor is further configured to control said ATU-R to communicate said first sub-channels using a one bit per symbol modulation scheme.

16. The apparatus of claim 14, wherein said processor is further configured to control said ATU-R to communicate a cyclic prefix in addition to said first sub-channels.

17. The apparatus of claim 14, wherein said processor is further configured to control said ATU-R to communicate a validity check in addition to said first sub-channels.

18. The apparatus of claim 14, wherein said processor is further configured to control said ATU-R to transmit said information for initializing said communication link using a two bit per symbol modulation scheme.
